(19) United States
(12) Patent Application Publication
(10) Pub. No.: US 2009/0162589 A1
(43) Pub. Date: Jun. 25, 2009

(54) POLYESTER COMPOSITIONS HAVING REDUCED GAS PERMEATION AND METHODS FOR THEIR PRODUCTION

(76) Inventors: Karl Buchanan, Kure Beach, NC (US); Chi-Chin Chen, Wilmington, NC (US); Helen Codd, Wilmington, NC (US); Peter Kezios, Wilmington, NC (US); Robert J. Schiavone, Matthews, NC (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/961,181

(22) Filed: Dec. 20, 2007

(51) Int. Cl. B32B 27/36; C08G 63/127; B29C 45/00; B29D 22/00

(52) U.S. Cl. 428/35.7; 428/480; 528/308.1; 264/328.17

(57) ABSTRACT

A polyethylene terephthalate and/or co-polyester composition containing one or more bisphenols. A method of making the composition, PET bottle preforms produced from the composition, a method of making a bottle by stretch-blow molding the composition and/or a preform thereof, bottles made from the composition, and a method of reducing the ingress and egress of gases through a film made from the composition.

### BACKGROUND OF THE INVENTION

1. Field of the Invention

The invention relates to compositions of polyethylene terephthalate, and/or co-polyesters of polyethylene terephthalate, with one or more of a bisphenol and a sulfonyl group-containing bisphenol, methods of making the compositions, PET bottle preforms produced from these compositions, methods of making a bottle by stretch-blow molding the compositions, bottles made from the compositions, and methods of reducing the ingress and egress of gases through films made from the compositions.

2. Description of the Related Art

Polyethylene terephthalate and co-polyesters of polyethylene terephthalate (polyethylene terephthalate and co-polyesters of polyethylene terephthalate are hereinafter referred to as PET) are preferred packaging materials for multi-serve and single-serve beverages. Beverages commonly packaged with PET include carbonated soft drinks, juice, juice drinks, water, flavored water (still and carbonated), hydration drinks, teas, new age drinks, milk and milk drinks, etc. PET has a number of properties that make its use for packaging such drinks favorable. For example, PET has mechanical strength in an oriented form, glass-like clarity, and gas barrier resistance, all of which are properties that make PET desirable as a material for beverage containers and which provide container design freedom.

Polyester resins such as poly(ethylene terephthalate) (PET), poly(butylene terephthalate) (PBT), poly(ethylene naphthalate) (PEN), poly(trimethylene terephthalate) (PTT), and poly(trimethylene naphthalate) (PTN), have conventionally been used as resins in the manufacture of food and beverage containers such as beverage bottles. Some resins such as PTT, PEN and PTN are used mainly for specialized packaging applications because these resins are significantly more expensive to manufacture than, for example, poly(ethylene terephthalate) resins. Properties such as flexibility, good impact resistance, and transparency, together with good melt processability, permit polyester resins to be widely used for making food and beverage containers.

PET and the other aforementioned polyesters do not meet all of the gas barrier requirements for small size single serve drink containers (e.g., containers for serving sizes of less than 20 oz.). To be acceptable for small size single serve drink containers a packaging container must be able to provide retention of CO₂ for carbonated soft drinks and exclusion of O₂ for oxygen sensitive drinks. Large, multi-serve containers made from PET generally meet the packaging requirements with respect to CO₂ retention and/or O₂ exclusion and are thus able to maintain the quality of the drink product reaching the consumer after filling, shipping, storage and purchase by the consumer. Similar performance in small size single serve drink containers is desirable to meet consumer demand for smaller serving size to provide convenience and portion control.

Different technologies have been applied to enhance the gas barrier properties of PET packaging materials. For example, PET containers may be coated with an internal and/or external coating to improve gas barrier performance. Other methods for improving gas barrier performance in PET containers include the use of multi-layer bottles, co-monomer substitution and the use of polymer blends.

Conventional technologies for improving gas barrier performance typically require the use of manufacturing equipment that is substantially more complicated, requires a greater initial capital outlay and greater operating expenses. Not only are the economic demands unfavorable, the use of such technologies can negatively affect the appearance and/or aesthetic properties of a container and/or the recyclability of PET containers.

Polymer blends are typically made from a mixture of a PET blended with another polyester material such as polyethylene naphthalate (PEN), polyethylene isophthalate (PEI) or other types of polymers such as polyamides (e.g., nylon). PET can also be modified by using co-monomers that are directly bonded to the polyester polymer chain. Co-monomers such as isophthalate-, naphthalate- and resorcinol-based diols may improve gas barrier performance. However, in order for a PET copolymer to achieve even moderate improvement in gas barrier performance, e.g., preferably a 1.2 to 2× or greater barrier improvement factor (e.g., an improvement in gas barrier resistance of at least 100%), the PET polymer normally requires the addition of 10-20 weight % or mole % of other co-monomers. This can substantially increase the cost of the PET resin and/or the complexity of the process used to manufacture the resin and bottles made from the resin, as well as create problems with other physical properties of the resin.

The addition of low molecular weight compounds to PET is a technology that has been used to improve gas barrier performance in PET polymer films, bottles and containers for packaging applications. Such low molecular weight compounds are typically referred to as molecular barrier additives. When present as a mixture with PET, low molecular weight compounds occupy free volume within the polymer matrix and may interact with different polymer chains through polar groups on the low molecular weight compound and the polymer chains. Robeson and Faucher disclosed in J. Polymer Science (1969) that the presence of certain low molecular weight compounds in polymeric materials such as polycarbonate, polyvinyl chloride, polyphenylene oxide, and polyethylene oxide may lead to an increase in the modulus of the polymeric material and concurrently reduce gas permeability. These effects were thought to be due to an anti-plasticization effect. Anti-plasticization is an effect whereby the chains of polymers in a polymeric matrix and/or polymer-containing composition have secondary interactions with other molecules, e.g., with a further compound or with other polymer molecules present in the matrix.

Ruiz-Trevino and Paul disclosed that certain low molecular weight compounds may function to improve the gas barrier properties of polysulfone membranes and/or films. It was speculated that a mechanism that results in interaction of the polar groups of the compounds with the polar groups of the polysulfones reduces the free volume of the polysulfone compositions, for example by bringing the polysulfone chains closer to one another. The resulting composition thereby provided reduced the gas permeability. The low molecular weight compounds were present in amounts from 10 to 30% by weight.

U.S. Pat. No. 6,489,386 discloses compositions that include one or more PET polymers and methyl-4-hydroxybenzoate and/or a compound related thereto. The addition of an ester-containing additive was found to affect gas barrier properties.

U.S. 2006/0275568 discloses the use of dialkyl esters of aromatic diacids as additives for PET compositions. Improved gas barrier performance was obtained without any significant change in the intrinsic viscosity (IV) of the composition when certain catalysts such as Ti— and Al-containing catalysts were used and the compositions were otherwise free of catalyst metals such as Sb, Co, Ca, etc.

U.S. 2005/0221036 discloses the use of naphthalene dihydroxides in PET compositions. The inclusion of compounds of formula HO-AR-OH, where the AR group is a naphthalene-containing group, was shown to reduce the gas permeability of the polymer compositions.

U.S. 2007/0082156 discloses the use of a purine derivative, particularly a purine dione such as caffeine as an additive to PET to improve the oxygen and carbon dioxide barrier properties of the resulting beverage container.

### SUMMARY OF THE INVENTION

Accordingly, one object of the invention is to provide PET compositions that have improved gas barrier performance including one or more of improved resistance to the passage of CO₂ gas through a film made from the PET composition and improved resistance to the passage of O₂ through a film made from the PET composition.

Another object of the invention is to provide a composition that is a thermoplastic blend of one or more PET polymers and one or more bisphenols.

Another object of the invention is to provide blends of PET and a phenylene group-containing bisphenol wherein the phenylene group is bonded to other aromatic groups through at most a single carbon atom.

Another object of the invention is to provide compositions of one or more PET polymers and one or more sulfonyl group-containing bisphenols.

Another object of the invention is to provide a PET composition containing one or more bisphenol compounds and having a barrier improvement factor of 1.05 or greater.

Another object of the invention is to provide a PET composition containing one or more bisphenol compounds and having a barrier improvement factor of 1.2 or greater.

Another object of the invention is to provide a PET composition containing one or more bisphenol compounds and having a barrier improvement factor of 2.0 or greater.

Another object of the invention is to provide a PET preform obtained by injection or compression molding a PET composition of the invention.

Another object of the invention is to provide a two stage process for forming a container, and containers made by the two stage process, including stretch blow molding a PET composition by first forming a preform by injection or compression molding and then heating the preform to an orientation temperature that is 20 to 40° C. above the glass transition temperature of the PET composition and stretch-blow molding to form a biaxially oriented container.

Another object of the invention is to provide a single stage process for making a container and a container made by the process, where the process includes conditioning a preform made from the PET composition at a stretch-blow molding temperature that is 20 to 40° C. above the glass transition temperature of the PET composition and immediately stretch-blow molding a container from the preform.

Another object of the invention is the production of containers by extrusion blow molding of a blend of a PET polymer and a bisphenol compound from an extruded parison and/or preform.

Another object of the invention is to provide a process that includes extruding an amorphous sheet from a blend of one or more PET polymers and one or more bisphenols and thermoforming containers from the amorphous sheets.

Another object of the invention is to provide an oriented film and a container made from a film of a PET composition that contains one or more PET polymers and one or more bisphenols and has improved gas barrier performance.

Another object of the invention is to provide a composition that is a thermoplastic blend of one or more PET polymers and one or more bisphenols where the bisphenols are substantially unreacted with the PET polymers.

Another object of the invention is to provide methods of making a PET composition that includes mixing one or more molten or solid PET polymers with one or more bisphenols to form a homogeneous blend of the PET polymers and the bisphenols.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a relationship between intrinsic viscosity and the molding temperature used to make a preform from a composition that includes one or more PET polymers and one or more bisphenols.

### DETAILED DESCRIPTION OF THE PREFERRED EMBODIMENTS

Suitable polyesters useful in the compositions of the invention are well known in the art and are generally formed from repeating units comprising one or more carboxylic acid components such as terephthalic acid (TPA), isophthalic acid (IPA), naphthalenedicarboxylic acid, dimethyl-2,6-naphthalenedicarboxylate (NDC), hydrolyzed 2,6-naphthalenedicarboxylic acid (HNDA), and one or more diol components such as ethylene glycol (EG), diethylene glycol (DEG), 1,4-cyclohexane-dimethanol, 1,3-propanediol, 1,4-butanediol, propylene glycol (1,2-propanediol), 2-methyl-1,3-propanediol, and 2,2-dimethyl-1,3-propanediol (neopentyl glycol), bis(hydroxyethyl) resorcinol and mixtures thereof. Preferably, more than 50 mol % of the monomer units of the polyester is terephthalic acid units. Preferred polyesters, co-polyesters and blends of the present invention include poly(ethylene terephthalate) (PET), poly(ethylene naphthalate) (PEN), poly(ethylene isophthalate) (PEI), and poly(trimethylene terephthalate) (PTT), poly(trimethylene naphthalate) (PTN), most preferably the polymer present in the compositions of the invention is poly(ethylene terephthalate) (PET).

The terms carboxylic acid and/or dicarboxylic acid, as used herein, include ester derivatives of the carboxylic acid and dicarboxylic acids. Esters of carboxylic acids and dicarboxylic acids may contain one or more C1-C6 alkyl groups (e.g., methyl, ethyl, propyl, iso-propyl, butyl, iso-butyl, tert-butyl, pentyl, hexyl and mixtures thereof) in the ester unit, for example, dimethyl terephthalate (DMT).

The dicarboxylic acid that may be used to make the polyester-containing compositions of the invention includes alkyl dicarboxylic acids having 2 to 20 carbon atoms preferably from 6 to 12 carbon atoms, and aryl- or alkyl-substituted aryl dicarboxylic acids containing from 8 to 24 carbon atoms, preferably from 8 to 16 carbon atoms. Additionally, alkyl dicarboxylic acid diesters having from 4 to 20 carbon atoms or alkyl-substituted aryl dicarboxylic acid diesters having from 10 to 20 carbon atoms can be utilized.

The dicarboxylic acid component of the polyester of the invention may optionally be modified with up to about 30 mol %, preferably up to about 25 mol %, more preferably about 20 mol % of one or more different dicarboxylic acids. In another embodiment of the invention the polyester is modified with less than 10 mol %, preferably less than 8 mol %, most preferably from 3 to 6 mol % of one or more different dicarboxylic acids. Such additional dicarboxylic acids include aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of dicarboxylic acids to be included with terephthalic acid in the resin composition of the invention in major or minor proportions include: phthalic acid, isophthalic acid, 5-(sodiosulfo)-isophthalic acid (5-Na⁺SO₃⁻-IPA), 5-(lithiosulfo)-isophthalic acid (5-Li⁺SO₃-IPA), naphthalene-2,6-dicarboxylic acid (and also the 1,4-, 1,5-, 2,7-, and 1,2-, 1,3-, 1,6-, 1,7-, 1,8-, 2,3-, 2,4-, 2,5-, 2,8- isomers), cyclohexanedicarboxylic acid, cyclohexanediacetic acid, diphenyl-4,4′-dicarboxylic acid, succinic acid, glutaric acid, adipic acid, azelaic acid, sebacic acid, bibenzoic, hexahydrophthalic, bis-p-carboxy-phenoxyethane, and mixtures thereof and the like. Preferred dicarboxylic acids include isophthalic and terephthalic acids.

Terephthalate polyesters for clear container applications are typically made from either a terephthalic acid and ethylene glycol, or from a terephthalic acid and a 1,4-cyclohexane diol. Suitable dicarboxylic acids include terephthalic acid, isophthalic acid, malonic, succinic, glutaric, adipic, suberic, sebacic, maleic and fumaric acid, all of which are well known dicarboxylic acids, or mixtures of these such that a copolyester is produced.

The diols used to make the polyester (e.g., a polyhydric glycols or diol) of the invention preferably contain from 2 to 8 carbon atoms, a most preferably diol is ethylene glycol (EG). Glycol ethers or diol ethers having from 4 to 12 carbon atoms may be substituted for the glycol or diol. Suitable glycols, in addition to ethylene glycol and 1,4-cyclohexanedimethanol (CHDM), include diethylene glycol, propylene glycol (1,2-propane diol), 1,3-propanediol, 2-methyl-1,3-propanediol, 2,2-dimethyl-1,3-propanediol (neopentyl glycol), 1,2-butanediol, 1,4-butanediol, pentaerythritol, similar glycols and diols, and mixtures thereof. These compounds and the processes for making polyesters and copolyesters using the compounds are all well known in the art.

In addition, the glycol component may optionally be modified with up to about 15 mol %, preferably up to about 10 mol %, more preferably about 5 mol % of one or more different diols other than ethylene glycol. Such additional diols include cycloaliphatic diols preferably having 6 to 20 carbon atoms or aliphatic diols preferably having 3 to 20 carbon atoms. Examples of such diols include: diethylene glycol, triethylene glycol, propylene glycol, 1,4-cyclohexanedimethanol, propane-1,3-diol, butane-1,4-diol, pentane-1,5-diol, hexane-1,6-diol, hexane-1,4-diol, 1,4-cyclohexanedimethanol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetra-methyl-cyclobutane, 2,2-bis-(3-hydroxyethoxyphenyl)-propane, neopentyl glycol, 2,2-bis-(4-hydroxypropoxyphenyl)-propane, mixtures thereof and the like. The polyesters of the invention may contain any combination of two or more of the above diols.

The polyester may also contain small amounts of trifunctional or tetrafunctional comonomers such as trimellitic anhydride, trimethylolpropane, pyromellitic dianhydride, pentaerythritol, and other polyester-forming polyacids or polyols generally known in the art.

Polyester resins are generally made by a combined esterification/polycondensation reaction between monomer units of a diol (e.g., ethylene glycol (EG)) and a dicarboxylic acid (e.g., terephthalic acid (TPA)). PET and PET co-polyesters may be produced by a variety of methods starting from chemical intermediates, terephthalic acid or dimethyl terephthalate (terephthalate component), and ethylene glycol. Additives such as catalysts and stabilizers may be added to facilitate the process and stabilize the polyester towards degradation. In the case of PET co-polyester production, either or both of the terephthalate component and/or the ethylene glycol component may be substituted on an equimolar basis with another di-acid, di-ester, and/or dihydroxy compound preserving the stochiometry between the hydroxyl and acid or ester groups.

In the first stage of the PET polymerization process used in one aspect of the invention to make a PET polymer for the composition of the invention, a pre-polymer is produced through esterification of terephthalic acid with a molar excess of ethylene glycol. The hydroxyl to acid mole ratio is typically in the range of 1.0 to 2.0. In the case of transesterification of dimethyl terephthalate with ethylene glycol, a similar mole ratio is used, and a transesterification catalyst is used to increase the reaction rate. For co-polyesters, the terephthalic acid, dimethyl terephthalate, or ethylene glycol can be substituted with another co-monomer on an equimolar basis, and a similar esterification or transesterification process is used to produce a pre-polymer. Diethylene glycol is produced as a by-product from ethylene glycol during esterification and transesterification and is present in the polyester as a result of being a by-product of the reaction. The concentration of diethylene glycol ranges from 0.5 to 2 weight percent depending on the process. In terms of co-monomer substitution, terephthalic acid or dimethyl terephthalate can be substituted with isophthalic acid or its dialkyl ester (i.e., dimethyl isophthalate), 2,6-naphthalene dicarboxylic acid or its dialkyl ester (i.e., dimethyl 2,6 naphthalene dicarboxylate), adipic acid or its dialkyl ester (i.e., dimethyl adipate), succinic acid, or its dialkyl ester (i.e., dimethyl succinate), or its anhydride (i.e., succinic anhydride). Ethylene glycol can be substituted with the following diol co-monomers; diethylene glycol, polyethylene glycol, 1,3-propanediol, 1,4-butanediol, 1,4-cyclohexane dimethanol, neopentyl glycol, bis(hydroxyethyl)resorcinol, and isosorbide. While the above co-monomers represent an extensive list of possible co-monomer substitutions, there are many other possible co-monomers.

The pre-polymer is polycondensed under reduced pressure to remove volatile products such as ethylene glycol, water and/or methanol (or other alcohol). To produce a bottle grade PET resin, a polyester polymer with an intrinsic or inherent viscosity, IV, in the range of 0.7 to 1.0 is preferred. Inherent viscosity may be measured according to ASTM D4603-96 (e.g., IV measured at 30° C. with 0.5 weight % concentration in a 60/40 by weight phenol/1,1,2,2-tetrachloroethane solution). The IV units are in dL/g.

Dilute solution viscosity of a polymer can be related to its molecular weight. During the polycondensation process in the melt state, polyester with an IV ranging from 0.4 to 1.0 is usually produced depending on the equipment and process conditions. When melt polycondensation is stopped short of the range needed for bottles, the lower IV PET precursor is extruded as a strand, quenched and granulated to produce an amorphous precursor usually with an IV in the range of 0.5 to 0.65. The amorphous pellet is crystallized and further polycondensed in a solid state polymerization process in the pellet form below the melting point of the polyester. The volatile products ethylene glycol, water, methanol, acetaldehyde are removed by an inert gas flow or under reduced pressure. The process is continued until the desired PET bottle grade IV is reached.

Other processes may be used without restriction to make the PET polymer used in the invention. For example, a process that includes forming a low molecular weight material having an intrinsic viscosity of from 0.1-0.4 then subjecting the low molecular weight material to solid state polymerization (such as the process described in U.S. Pat. No. 6,284,866, incorporated herein by reference in its entirety).

In another process for producing bottle grade PET, a polyester resin with the desired IV is produced completely in the melt phase through the use of specially designed equipment in a process that handles the high melt polymer viscosity. After reaching the desired IV in the melt, the polymer is extracted, granulated, and crystallized for use in the PET bottle production process.

The composition of the invention includes a bisphenol. A bisphenol is an alkylene diphenol which may be obtained by the condensation of two equivalent amounts of a phenol and an aldehyde or a ketone. Well known bisphenols include BPA (bisphenol A=4,4′-dihydroxy-2,2-diphenylpropane).

Preferably, the phenylene units of the bisphenol are linked by a hydrocarbon group that contains only alkylene units (—CR₂—) with R being hydrogen or alkyl from 1-12 carbons, preferably only a methylene (—CH₂—) group. The alkylene group preferably contains no other heteroatom-containing group such as an ester group and/or an amide group. Other alkylene groups linking one phenylene/phenol group to another may be used such as ethylidene, n-propylidene, i-propylidene, butylidene, pentylidene and other alkylidene groups having, for example 6 or more carbon atoms and isomeric forms thereof. The bisphenol must have at least two phenolic units and may have more than two phenylene units. The bisphenol may be symmetric or asymmetric.

In one aspect of the invention the PET composition includes a bisphenol having a phenylene group that is bonded to other aromatic groups such as phenylene groups through no more than one direct carbon-carbon bond where the carbons of the bond are carbon atoms in a phenylene group.

In one embodiment of the invention the bisphenol has structure I shown below.

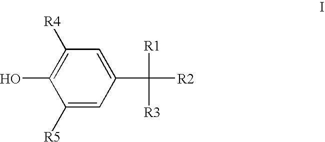

In structure I above, R1 and R3 are hydrocarbon groups having up to 12 carbon atoms, preferably R1 and R3 are alkyl groups having from 1-6 carbon atoms or a cycloaliphatic group, more preferably R1 and R3 are a methyl group or a hydrogen atom. More preferably R1 and R3 are both alkyl groups. The R2 group is a phenylene group-containing phenol of formula II of the group of phenolic units shown below.

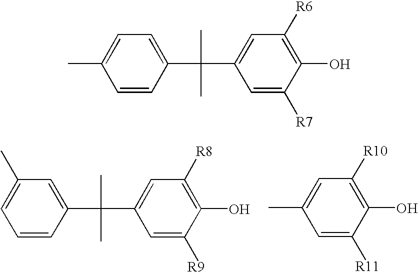

The groups R4-R11 are preferably hydrocarbon groups having up to 12 carbon atoms, more preferably the R4-R11 groups are alkyl groups having up to 6 carbon atoms, most preferably the R4-R11 groups are a methyl group or a hydrogen atom, even more preferably R4-R11 are all methyl groups.

In another aspect of the invention the bisphenol material contains a sulfonyl (SO₂) group. The sulfonyl is preferably bonded to at least two phenolic groups that contain a phenylene group. Preferably, the sulfonyl group-containing bisphenol has a structure II shown below.

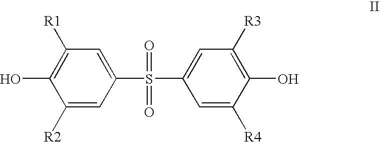

In structure II above, the R1-R4 groups are, independently of one another, preferably hydrocarbon groups containing up to 12 carbon atoms or hydrogen atoms. Hydrocarbon groups include aromatic groups or alkyl groups containing one or more aromatic groups. Preferably R₁-R4 are alkyl groups containing up to 6 carbon atoms, most preferably R1-R4 are methyl groups or hydrogen atoms, even more preferably R1-R4 are all methyl groups.

The bisphenol may be present in the PET blend in amounts of up to 10% by weight based upon the total weight of the bisphenol and the total weight of the PET blend. Preferably the bisphenol is present in an amount of from 0.1 to 10% by weight based upon the total weight of the PET composition, more preferably, the bisphenol is present in an amount of from 2 to 8% by weight, even more preferably the bisphenol is present in an amount of from 4 to 8% by weight. All values, ranges and subranges between the stated values are expressly included herein.

Preferably the amount of water present in the bisphenol before it is mixed with the PET polymer is less than 1% by weight based upon the total weight of the bisphenol powder. Even more preferably, the amount of water present in the bisphenol is less than 0.5, less than 0.4, 0.3, 0.2, 0.1%. Most preferably, the amount of water is less than 100 ppm, and even more preferably less than 10 ppm in the bisphenol. Greater amounts of water can lead to discoloration and changes in the intrinsic viscosity of the underlying PET polymer induced when the bisphenol/polymer mixture is melted and/or injection molded.

The polyester compositions and/or polymers described herein may contain one or more other elements or components conventionally used in the manufacture of polyester resins. For example, a typical composition may contain elements such as Co, Sb and/or P that may be present in the resin compositions due to their presence in the catalysts, heat stabilizers, and colorants used during the polymerization and/or processing of polyester resins. For example, Sb, Ge, Ti, Al, or Sn may be used for melt polymerization, for example, in the form of organic titanates, dibutyl tin dilaurate, tin organics, germanium dioxide, antimony trioxide (Sb₂O₃), antimony triacetate, and/or antimony glycolate (Sb₂(gly)₃) or oxides of the respective metals (e.g., TiO₂, GeO₂ etc.). Phosphorous may be present as a residue from any trialkyl phosphate or phosphite present during the polymerization and/or processing of the resulting resins. Elements that are present as residues from coloring agents used, for example, to modify and/or control yellowness index such as Co(OAc)₂ may also be present. Typically the materials that are present as residues from polymerization catalysts or processing additives are present in an amount of 10-1,000 ppm, preferably 50-500 ppm.

The compositions are preferably thermoplastic. A thermoplastic composition and/or blend are one that undergoes softening or melting upon heating and returns to a solid state when cooled. Thermoplastic compositions may be subjected to repeated heating and cooling cycles with no substantial chemical change.

The present composition can be prepared by a variety of methods. For example, the bisphenol additive can be fed directly into the polyester during the preform injection or compression molding process, preblended with the polyester resin prior to preform injection or compression molding, or incorporated at high concentrations with PET as a masterbatch and then blended with the polyester resin prior to preform injection or compression molding. Other alternatives include combining the bisphenol additive with the polyester in the initial production of the polyester chip (i.e. during extrusion of the melt PET), dry blending of the bisphenol with PET chip followed by injection or compression molding of performs from the blended product, as well as the alternatives further detailed below. Preferably, the process is performed in such a way to minimize the thermal history of the blend once formed.

The PET composition is preferably in a homogeneous form. Preferably, the homogeneous PET composition is in the form of pellets which may be used, for example, to form preforms which may later be used in blow molding to form containers and/or food packaging products. The homogeneous PET composition may take several forms. For example, in one form the homogeneous composition does not include any loose bisphenol but instead includes bisphenol materials adhered to the surfaces of pellets of the PET polymer. The bisphenol material can be made to adhere to the surfaces of the pelletized PET polymer by treating and/or coating the PET polymer with a solution of the bisphenol and drying. A homogeneous PET composition made in this manner is advantageous because it minimizes the heat history of the underlying PET polymer and/or pellets.

Alternatively or in addition, the PET polymer may be in a form wherein the bisphenol compound is homogeneously distributed throughout the PET matrix. In this embodiment of the invention the bisphenol is present throughout the polymer matrix. Such a homogeneous PET composition may be made by melting the underlying PET polymer and adding thereto the bisphenol and subsequently pelletizing the resulting mixture. Alternatively, the PET polymer may be dissolved in a solvent to which the bisphenol compound is added. Subsequent removal of the solvent provides a PET polymer within which the bisphenol compound is homogeneously distributed. Preferably, the bisphenol material is mixed with molten PET polymer to thereby obtain a single component, pelletized form of the PET composition of the invention.

In another embodiment pellets, chips and/or particles of the PET polymer are used as a dry blend with the powder of a bisphenol. The bisphenol is therefore not located or dispersed within the polymer matrix of the PET composition. One advantage of a dry blend containing both particles of the polymer and particles of the bisphenol compound is the relative low cost to prepare such mixtures.

In the context of the invention the term “not reacted with” indicates that the bisphenol compound is not covalently bonded to any PET polymer through any group or substituent. Preferably, the bisphenol compound resides in the free volume of the PET composition dispersed in the PET polymers. The bisphenol may be partially reacted with and bonded to the PET polymers of the PET composition. Preferably, less than 20% by weight of the bisphenol compounds are reacted with or bonded to any polymer in the PET composition, where weight percent is based upon the total weight of any bisphenol that is bonded to or reacted with a polymer and the total weight of all of the bisphenol. More preferably, less than 15% by weight of the bisphenol compounds are reacted and/or bonded to any polymer, even more preferably less than 10% by weight, especially preferably less than 5% by weight, less than 4% by weight, less than 3% by weight, less than 2% by weight, less than 1% by weight, less than 0.5% by weight and particularly preferably less than 0.1 or 0.01% by weight, any fractions, multiples or derivatives of the stated values are expressly included as are any ranges between the stated values or subranges therebetween.

It is particularly preferable that the bisphenol is not reacted with, covalently bonded to and/or ionically bonded to any PET polymer and/or any other polymer in the PET composition of the invention. Most preferably, any unreacted bisphenol is present in the free volume of the PET composition between polymer chains.

The amount of bisphenol that is present in the free volume of the PET composition may be determined by measurements such as nuclear magnetic resonance (NMR). The amount of free bisphenol that is not reacted with or bonded to any polymer may be distinguished and quantified separately from any bisphenol that is reacted with and/or bonded to any polymer in the composition of the invention. Preferably, ¹³C NMR is used to differentiate between the carbon atoms of the bisphenol compound connected to hydroxyl groups (e.g., carbon atoms in unreacted bisphenol compound) and compared to the ¹³C signal for the carbon atom bonded to the oxygen atom which is bonded to or reacted with a polymer. Other techniques include ¹H NMR whereby different signals for the proton resonances of the bisphenol molecule may be used to determine a relative ratio of reacted and unreacted bisphenols. Infra-red and/or Raman analysis may also be used to determine the relative amounts of free and reacted bisphenol compounds.

A detailed description of re-heat stretch blow molding processes to produce bottles can be found in Shell Chemical Company's “Polyester Product Manual,” incorporated by reference in its entirety.

The PET composition may be converted into bottles by a two step process designed to maximize the gas barrier performance of the PET bottles. In the first step of the process, a PET preform is made by injection or compression molding dried PET pellets. The drying of PET pellets minimizes the drop in the IV of the PET caused by molding so that maximum bottle properties and performance can be obtained. The typical temperature for PET copolymer melt processing is between 270 and 300° C. and the melt residence time are typically less than two minutes. The preform is designed to be stretch-blow molded into a container so that the PET in the container walls is sufficiently oriented for the intended application. The preform is reheated to a temperature in the range of 20 to 40° C. above the glass transition temperature. The orientation of PET during the blow-molded process is affected by the IV, preform reheat temperature, moisture, etc. Orientation improves mechanical performance and reduces the gas permeability of the container. While this process improves the gas barrier of properties PET, the gas barrier which is not sufficient in most cases for shelf-life of single serve PET containers. In a single stage process in which a container is the end result, a preform is produced by injection or compression molding which is then conditioned to achieve the orientation temperature and stretch-blow molded into a bottle. The preform is not isolated as in the two stage process, but a preform is still produced.

Surface area to volume ratio is one reason small containers suffer from higher leakage rates than larger containers. Since the mechanism for gas permeability involves, first, the dissolution of the gas in wall of the container followed by diffusion of gas molecules from high concentration side to the low concentration side, higher surface area relative to volume allows a greater portion of the gas penetrant to dissolve in the sidewall and diffuse resulting in shorter shelf life for the package. Not to be bound by any particular theory, it is assumed that the presence of bisphenols reduces the solubility of gases such a CO₂ or O₂ by reducing the free volume available to the gas molecule in PET polymer and impedes diffusion through a film or bottle sidewall through an anti-plasticization mechanism.

The free volume model of polymer diffusion employs the concept of discrete holes being present in the polymer matrix. Free volume V_{f} in the polymer matrix is defined as V_{f}=V-Vₛ where V is the specific volume and Vₛ is specific molecular volume of polymer due to steric size and thermal vibrations. The discreet holes are formed from the Brownian motion of polymer segments. The size of the holes in the polymer due to its free volume controls the ability of a penetrant or gas molecule to move through the polymer matrix. When a hole of large enough size is formed (a void of critical size) through Brownian fluctuations, the diffusing molecule can move or jump to the newly form hole. The jump frequency of a gas molecule is higher than a polymer segment so the Brownian movement of polymer segments is the rate controlling mechanism for gas diffusion according to the free volume model of diffusion. The presence of atoms or molecules in the free volume of a polymer composition may reduce hole size or number of holes available to the gas molecule for diffusion through the polymer. Also if the atoms or molecules occupying the free volume can interact with the polymer chains, then the segmental motion of the polymer chain through Brownian motion may retard the creation of new holes and reduce the diffusion of gas molecules through the polymer.

### EXAMPLES

The following additives (12, 13, 26, 27, 28, and 30) were dry blended with PET resin and melted and mixed together in the extruder of an injection molding machine. Then the melt was injected in a PET bottle preform mold to produce preforms containing PET in combination with the additive. The melt temperature in the extruder should be kept as low as possible to minimize reaction between the molecular barrier additive and PET. Higher co-monomer levels in PET co-polyesters are useful to lower the melt temperature during preform injection molding. The preforms were blow molded into bottles and tested for their retention of carbon dioxide after being pressurized to four volumes of carbon dioxide gas (carbonation). The retention of CO₂ was determined by the FTIR test method disclosed in U.S. Pat. No. 5,473,161. The loss of carbon dioxide was measured by the FTIR method and the number of weeks (shelf-life) until a loss of 17.5% of the carbonation was projected after 25 and 49 days by the test. An increase in the number of weeks to reach the given CO₂ level indicates the PET bottle is less permeable to CO₂ gas. The ratio of the number of weeks for loss of CO₂ for the additive containing bottles to the weeks for control bottle (no additive) gave the barrier improvement factor (BIF).

### Additives

Additive 11—Methyl hydroxybenzoate (MHB)
Additive 12—4,4′-Sulfonyldiphenol (Bisphenol S)
Additive 13—4,4′-Sulfonylbis(2-methylphenol)
Additive 14—BHT
Additive 15—Irganox 1010
Additive 26—4,4′-(1,4-phenylenediisopropylidene)-bisphenol (Bisphenol P)
Additive 27—4,3′-(1,3-phenylenediisopropylidene)-bisphenol (Bisphenol M)
Additive 28—Irganox 1098
Additive 30—Isopropylidene bis(2,6-dimethylphenol)

TABLE 1
Shelf Life and Barrier Improvement of PET with Molecular Barrier Additives

| | | | 25-day | 49-day | | Sidewall |
|---|---|---|---|---|---|---|
| | | Additive | projected | projected | Barrier | Cryst (%)/ |
| | Base | Conc. | shelf life | shelf life | Improvement | Preform |
| Additive | Resin | (wt %) | (weeks) | (weeks) | Factor (BIF) | IV |
| None | Laser+ | 0 | 8.8 | 9.0 | — | 29.2/0.79 |
| 12 | Laser+ | 1 | 9.2 | 9.6 | 1.07 | 20.4/0.67 |
| 12 | Laser+ | 2 | 10.2 | 10.4 | 1.16 | 23.0/0.60 |
| 13 | Laser+ | 2 | 9.6 | 10.1 | 1.12 | 21.5/0.67 |
| None | Laser+ | 0 | 9.3 | 9.3 | — | 23.6/0.77 |
| None | Optra M | 0 | 9.1 | 9.7 | 1.04 | 23.6/0.835 |
| 12 | Optra M | 4 | 11.4 | 12.2 | 1.31 | 23.2/0.63 |
| 13 | Optra M | 4 | 11.1 | 11.8 | 1.27 | 20.5/0.66 |
| 26 | Optra M | 4 | 10.0 | 10.9 | 1.17 | 6.8/0.70 |
| 26 | Optra M | 6 | 11.1 | 11.4 | 1.23 | 17.5/0.66 |
| 27 | Optra M | 4 | 12.2 | 11.9 | 1.28 | 12.5/0.70 |
| 27 | Optra M | 6 | 12.2 | 12.9 | 1.39 | 17.5/0.69 |

TABLE 2
Comparative Examples

| | | | 25-day | 49-day | | Sidewall |
|---|---|---|---|---|---|---|
| | | Additive | projected | projected | Barrier | Cryst (%)/ |
| | | Conc. | shelf life | shelf life | Improvement | Preform |
| Additive | Base Resin | (wt %) | (weeks) | (weeks) | Factor (BIF) | IV |
| 11* | Laser+ | 4 | 8.6 | 9.1 | 1.01 | 21.2/0.75 |
| 14* | Laser+ | 4 | 8.9 | 9.4 | 1.04 | 27.8/0.77 |
| 15* | Laser+ | 4 | 8.2 | 8.7 | 0.97 | 18.9/0.79 |
| 28 | Optra M | 2 | 9.0 | 8.9 | 0.96 | 10.7/0.79 |

*MHB, BHT, and Irganox 1010 were first melt compounded with Laser+ then solid state polymerized to an IV of 0.80, 0.82, 0.81, respectively before injection molding into a preform.

The preform injection molding temperatures of the above examples ranged from 260° C. for Laser+ to 245° C. Optra M which has a higher level of co-monomer and a lower melting point. Compounds of Optra M and Additive 13 had to be molded at 260° C. because of the high melting point of Additive 13. The effect of injection molding temperature on preform IV can be seen in the following examples tabulated below.

TABLE 3
Effect of Injection Molding Temperature
on Additives 12 and 13 with Optra M at 4 weight %.

| Condition | Injection Temp | |
|---|---|---|
| Code | (° C.) | IV (dL/g) |
| Additive 12 | 245 | 0.63 |
| 4 weight % | 250 | 0.59 |
| | 255 | 0.58 |
| Additive 13 | 245 | 0.69 |
| 4 weight % | 250 | 0.68 |
| | 255 | 0.66 |
| | 260 | 0.66 |

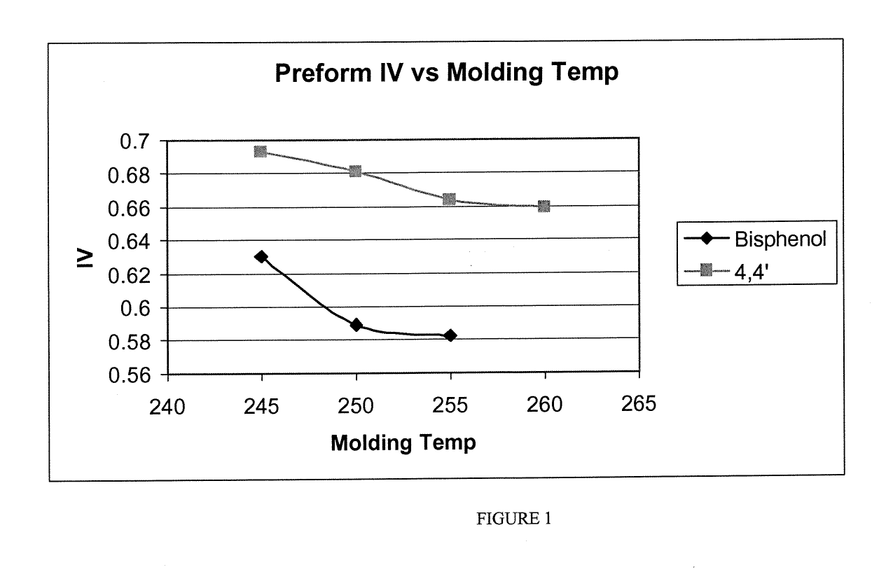

The IV versus injection molding temperature for additives 12 (4,4′-sulfonyldiphenol (bisphenol S)) and 13 (4,4′-sulfonylbis(2-methylphenol)) is shown in FIG. 1. Lower injection molding temperature reduces the IV drop.

To further reduce the IV drop, the additives were dried under vacuum. Then the dried additives were dry blended with dried PET to give a dry blend with less than 50 parts per million of moisture.

TABLE 4

| | | | Preform | |
|---|---|---|---|---|
| | | | Injection | |
| | Additive | | Molding | |
| Resin | (weight %) | Moisture (ppm) | Temp. ° C. | IV |
| Laser+ | None | 4.4 | 255 | 0.81 |
| Optra M | None | 4.2 | 248 | 0.85 |
| Optra M | 27 (6) | 22.4 | 244 | 0.75 |
| Optra M | 27 (8) | 42.7 | 243 | 0.76 |
| Optra M | 30 (6) | 48.9 | 243 | 0.84 |
| Laser+ | 30 (6) | 45.0 | 255 | 0.79 |
| Laser+ | 27 (6) | 40.2 | 254 | 0.71 |

The dry blends were injection molded into preforms and blow molded into bottles. The bottles were tested for their improvement to CO₂ loss by the method described in U.S. Pat. No. 5,473,161 which is incorporated herein by reference in its entirety.

TABLE 5

| | | | 25-day | 49-day | |
|---|---|---|---|---|---|
| | | Additive | projected | projected | Barrier |
| | Base | Conc. | shelf life | shelf life | Improvement |
| Additive | Resin | (wt %) | (weeks) | (weeks) | Factor (BIF) |
| None | Laser+ | 0 | 9.1 | 9.4 | — |
| None | Optra M | 0 | 9.4 | 9.7 | — |
| 27 | Optra M | 6 | 13.0 | 13.1 | 1.35 |
| 27 | Optra M | 8 | 11.6 | 12.6 | 1.30 |
| 30 | Optra M | 6 | 13 | 12.7 | 1.31 |
| 30 | Laser+ | 6 | 10.6 | 11.1 | 1.18 |
| 27 | Laser+ | 6 | 12.4 | 13.0 | 1.38 |

For PET bottle stretch blow molding, the blow molding machine was set up to produce bottles with a standard PET resin. The preform reheat temperature for CSD bottles is typically set by using a reheat oven setting at 2% above the pearlesence point (temperature) for maximum orientation. This setting maximizes the performance of carbonated soft drink bottles for strength and CO₂ gas barrier and gives a glass-like bottle. PET preforms (either Laser+ or Optra M) with each additive were blow molded to first give material distribution needed for bottle performance as established by the standard PET resin. Then, to maximize performance, the bottles were blow molded at an overall reheat oven setting of 2% above the pearlesence point and maintaining the material distribution.

TABLE 6
Preform Free Blow Results for Preforms Blown at 97° C. and 50 psi

| | Additive | | | Axial | Radial | Areal |
|---|---|---|---|---|---|---|
| | Concen- | | | Stretch | Stretch | Stretch |
| Additive | tration | Base Resin | IV | Ratio | Ratio | Ratio |
| None | 0 | Laser+ | 0.81 | 2.7 | 5.9 | 16.0 |
| None | 0 | Optra M | 0.85 | 2.6 | 6.0 | 15.7 |
| 27 | 6 | Optra M | 0.75 | 3.6 | 6.5 | 23.4 |
| 27 | 8 | Optra M | 0.76 | 3.8 | 6.8 | 26.0 |
| 30 | 6 | Optra M | 0.84 | 2.9 | 5.8 | 17.0 |
| 30 | 6 | Laser+ | 0.79 | 2.8 | 5.8 | 16.4 |
| 27 | 6 | Laser+ | 0.71 | 3.1 | 6.1 | 19.0 |
| None | 0 | Optra M | 0.68 | 3.6 | 6.1 | 21.8 |
| None | 0 | Optra M | 0.70 | 3.1 | 6.2 | 19.0 |

To maximize the performance of PET bottles for carbonated soft drink applications, preforms should be stretch blow molded into bottles close to the strain hardening limit of PET resin in the preform. Factors affecting the strain hardening behavior of PET are IV, co-monomer content, moisture content, additives, etc. One way to determine the effect of composition on the strain hardening limit of a PET preform is to produce a free blown balloon of the preform. The free blown balloon is formed by blowing the preform outside of a bottle mold. During free-blowing, where a blown preform balloon is unconstrained by a bottle mold, the achievable balloon size should be limited by resin strain hardening to a size near that of the intended molded bottle. The free blown balloons can also be used as a comparative result to determine the effect of composition on the stretching characteristics of a given PET composition.

To quantify the effect of composition during free blow, a circle is inscribed on the outside of the preform for use in calculating the stretch ratio of preform. Bottles are typically produced in a cylindrical shape thus resulting in axial and radial components to the stretch ratio. The changes in the dimensions of the circle in the axial and radial directions are used to calculate the areal stretch ratio. The areal stretch ratio is the product of the axial and radial stretch ratios. The results in Table 6 show that the primary effect on the overall areal stretch ratio is the IV and the molecular barrier additives at these levels have a small to modest influence on the stretch ratio depending on the type of bisphenol additive.

While not to be bound by any particular theory, the observations of the effect of the molecular barrier additives on the free blow of PET preforms supports anti-plasticization of PET by the diphenolic compounds though an interaction between the aromatic hydroxyl group and oxygen atoms in the ester group of PET. It is important that the diphenols remain a separate molecular entity to both occupy the free volume and function as an anti-plasticizer for PET.

The importance of preserving the bisphenols as preferably separate molecular entities to function as molecular barrier additives can be seen in the following examples (Table 7) in which Additive 30 is incorporated into a PET perform by dry blending, melt extrusion, and melt extrusion followed by SSP. In the case of dry blending, Additive 30 powder is dry blended with PET pellets prior to injection molding preforms. In melt extrusion, Additive 30 is first incorporated into the PET matrix by extruding a blend of Additive 30 with PET pellets. Then the pellets are dried and injection molded into preforms. In another example, the extruded pellets are solid state polymerized to higher IV then injection molded into preforms.

The preforms were blow molded into 20 oz. bottles and the BIF was measured using the method described in U.S. Pat. No. 5,473,161 which is incorporated herein by reference in its entirety.

TABLE 7

| | Additive 30 | | | |
|---|---|---|---|---|
| | Concentration | Incorporation | | |
| PET Resin | (wt %) | method | IV | BIF |
| Laser + C | 8 | Dry blend | 0.74 | 1.4 |
| Laser + C | 8 | Melt extrusion | 0.76 | 1.3 |
| Laser + C | 8 | Melt | 0.77 | 1.2 |
| | | extrusion/SSP | | |

The results in Table 7 show that multiple melt processing and additional polymerization by SSP leads to bottles with a lower BIF performance compared to dry blending. These results support the theory that the bisphenol molecular barrier additive should preferably remain a separate molecular entity for gas barrier, and thermal history of the resulting composition should be minimized to avoid incorporation of the bisphenol into the polymer molecule itself. The further melt extrusion or melt extrusion/SSP can lead to incorporation of the bisphenol additive into the polymer reducing the concentration of the discrete molecular barrier additive, thereby reducing the BIF.

Obviously, numerous modifications and variations of the present invention are possible in light of the above teachings. It is therefore to be understood that within the scope of the appended claims, the invention may be practiced otherwise than as specifically described herein.

1. A thermoplastic PET composition, comprising:
a PET matrix comprising (i) one or more PET polymers, and
(ii) one or more bisphenols selected from the group consisting of bisphenols having hydroxy groups bonded only to phenylene groups that are bonded to other aromatic groups through at most one carbon atom and bisphenols having a sulfonyl group.

2. The PET composition of claim 1, wherein the content of the one or more bisphenols is an amount of from 0.1 to 10% by weight based upon the total weight of the PET composition.

3. The PET composition of claim 1, wherein no more than 0.1% by weight of the total amount of the one or more bisphenols is reacted with or bonded to any PET polymer present in the PET composition.

4. The PET composition of claim 1, having a barrier improvement factor of at least 1.05.

5. The PET composition of claim 1, having a barrier improvement factor of at least 1.1.

6. The PET composition of claim 1, having a barrier improvement factor of at least 1.2.

7. The PET composition of claim 1, wherein the bisphenol has hydroxyl groups bonded only to a phenylene group that is not bonded to any other aromatic group through at most one carbon atom and the bisphenol is present in an amount of from 0.1 to 10% by weight.

8. The PET composition of claim 1, wherein the bisphenol has the following structure I: 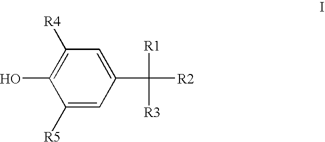
wherein R1 and R3 are each, independently, a hydrogen atom or an alkyl group having from 1-6 carbon atoms and R2 group is one or more of 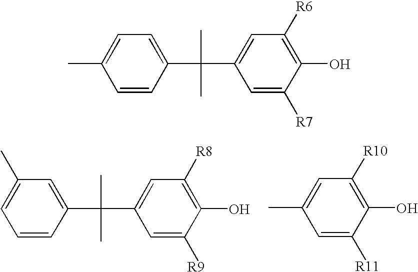
wherein R4-R11 are each, independently, a hydrogen atom or an alkyl group having up to 6 carbon atoms.

9. The PET composition of claim 1, wherein the bisphenol is a sulfonyl group-containing bisphenol group having the following structure II: 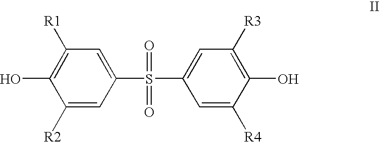
wherein R1-R4 are each, independently, a hydrogen atom or an alkyl group having up to 6 carbon atoms.

10. The PET composition of claim 9, wherein R1-R4 are each, independently, a methyl group or a hydrogen atom.

11. An article made from the PET composition of claim 1, wherein the article is a member selected from the group consisting of a film, a resealable food or beverage container, an amorphous sheet, and a preform for forming a resealable food or beverage container.

12. The article of claim 11, wherein the article is a film.

13. The article of claim 12, wherein the film is a biaxially oriented film.

14. The article of claim 11, wherein the article is a resealable food or beverage container.

15. The article of claim 14, wherein the resealable food or beverage container has a serving size of 20 oz. or less.

16. The article of claim 11, wherein the article is an amorphous sheet.

17. The article of claim 11, wherein the article is a preform for forming a resealable food or beverage container.

18. A method for production of a PET gas barrier composition, comprising:
combining (i) one or more PET polymers, and (ii) one or more bisphenols selected from the group consisting of bisphenols having hydroxy groups bonded only to phenylene groups that are bonded to other aromatic groups through at most one carbon atom and bisphenols having a sulfonyl group.

19. The method of claim 18, wherein said combining is performed by providing the one or more PET polymers in a melt state and combining the melt with the one or more bisphenols.

20. The method of claim 18, wherein said combining is performed so as to minimize thermal history of the resulting PET gas barrier composition.

21. The method of claim 19, wherein after said combining, the PET gas barrier composition is formed into polymer chip.

22. The method of claim 19, wherein after said combining, the PET gas barrier composition is directly injection molded or compression molded into a preform without having been formed into a polymer chip.

23. The method of claim 19, wherein said combining is performed in an extruder during injection or compression molding of a preform.

24. The method of claim 19, wherein said combining is performed in an extruder.

25. The method of claim 20, wherein after said combining, the PET gas barrier composition is formed into polymer chip.

26. The method of claim 20, wherein after said combining, the PET gas barrier composition is directly injection molded or compression molded into a preform without having been formed into a polymer chip.

27. The method of claim 20, wherein said combining is performed in an extruder during injection or compression molding of a preform.

28. The method of claim 20, wherein said combining is performed in an extruder.

29. The method of claim 18, wherein said one or more PET polymers are in the form of polymer chip and said one or more bisphenols are combined with said one or more PET polymers by dry blending to provide a dry blend product.

30. The method of claim 29, further comprising melt extruding said dry blend product.

31. The method of claim 18, further comprising blending of said PET gas barrier composition with one or more additional PET polymers, which can be the same as or different from said one or more PET polymers (i).

32. The method of claim 19, further comprising blending of said PET gas barrier composition with one or more additional PET polymers, which can be the same as or different from said one or more PET polymers (i).

33. The method of claim 20, further comprising blending of said PET gas barrier composition with one or more additional PET polymers, which can be the same as or different from said one or more PET polymers (i).
